(19) United States
(12) Patent Application Publication
(10) Pub. No.: US 2011/0023497 A1
(43) Pub. Date: Feb. 3, 2011

(54) Method for Purifying Biogas

(76) Inventor: Tobias Assmann, Munich (DE)

Correspondence Address: HOUSTON ELISEEVA, 420 BEDFORD ST, SUITE 155, LEXINGTON, MA, 02420, US

(21) Appl. No.: 12/745,341

(22) PCT Filed: Dec. 3, 2008
(86) PCT No.: PCT/EP08/66730

§ 371 Date: May 28, 2010

(30) Foreign Application Priority Data
Dec. 5, 2007 (DE) 10 2007 058 548.0

(51) Int. Cl. F02G 3/00

(52) U.S. Cl. 60/780; 60/39.12

(57) ABSTRACT

The invention relates to a method and apparatus for the production and purification of biogas. This involves in principle the production of biogas from biomass in a fermenter. The biogas is divided by means of a separation stage into a methane gas flow and a lean gas flow, and the lean gas flow is converted into heat and electrical power in a combined heat and power plant. The invention is characterised in that, by means of a bypass line which circumvents the separation stage, a variable proportion of the crude gas flow may be fed directly to the combined heat and power plant.

The present invention relates to a method for the purification of biogas.

Biogas is obtained from the fermentation of organic substances. It contains the gases methane, carbon dioxide and water vapour, together with traces of hydrogen sulphide, ammonia, HCl, hydrogen, volatile organic acids and siloxane/silane.

The use of the biogas for energy occurs nowadays largely in combined heat and power plants, i.e. large amounts of electricity and low-temperature heat are produced close to the biogas plant. While the electricity can be fed into the grid, a low-temperature heat consumer is not always available locally, so that in the worst case the heat must be cooled down at an additional cost in energy.

The processing of the biogas to natural gas quality, the compression and conveyance of the methane to a combined heat and power plant close to a heat consumer, is therefore an alternative to local combined heat and power plants which is of growing importance.

Unlike electricity grids, local gas grids have only limited buffer or equalisation capacity to deal with a temporary surplus of bio-methane. When maximum pressure in the natural gas grid is reached, it is generally necessary to flare off some or all of the biogas.

There is therefore a considerable demand for processing biogas into methane of natural gas quality, without the need to burn off biogas in the event of fluctuating acceptance capacity.

The standard adsorption process is that of pressure swing adsorption (PSA), as described for example in CH 692 653 A5. This involves the bonding to an active carbon or molecular sieve surface of carbon dioxide and polar associated gases under high pressure. Methane adsorbs much more poorly than carbon dioxide and the associated gases. After the adsorbent is charged, pressure is reduced and the impurity desorbs again and is drawn off as lean gas. The process is therefore not continuous but may be quasi-continuous with several columns connected in parallel. The PSA process generates high-purity methane flows. However, small amounts of methane (in the single-digit percentage range) still occur in the lean gas. Since methane is a very harmful climate gas, it should not be released into the environment.

Apart from the high investment costs, a basic drawback of PSA is that it cannot be operated so as to be self-sufficient in energy. Both the electrical energy for the biogas plant, and also the compression energy to produce the mains pressure must be provided from an external energy source.

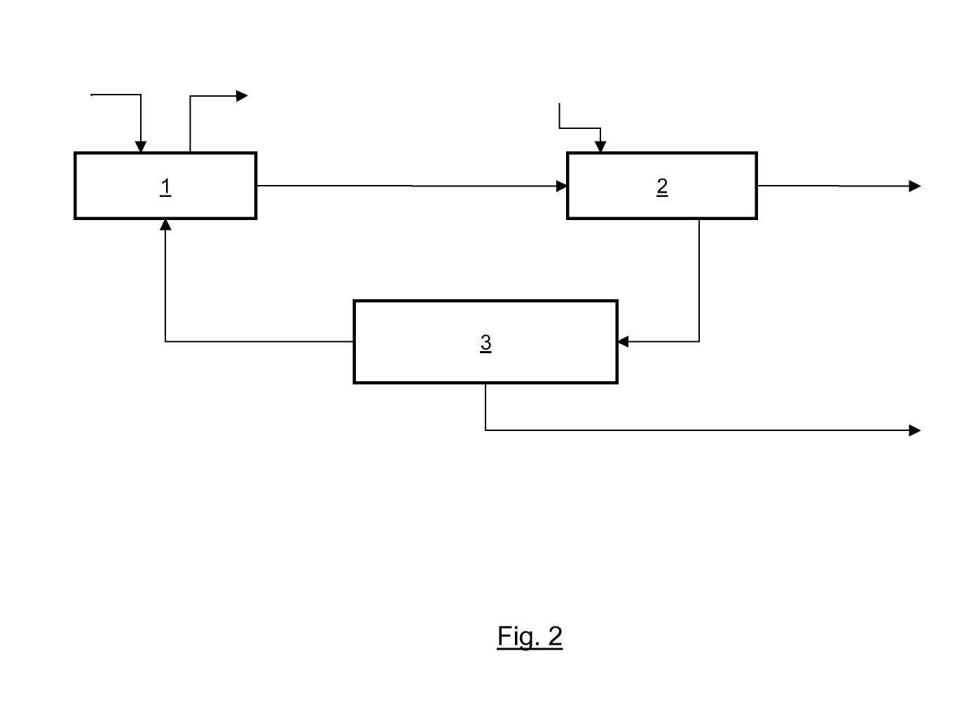

Described in EP 1 634 946 A1 is a process for the production of bio natural gas, shown schematically by a block diagram in FIG. 2. In this process, firstly crude biogas is produced from biomass in a fermenter 1. The crude biogas is fed to a treatment stage 2 in which bio natural gas is produced from the crude biogas, while an additional waste gas flow with a methane content of 17% by volume occurs. The treatment stage operates by means of a carbon-based molecular sieve without recirculation. The methane of the waste gas flow is burned to produce heat, using a lean gas burner. It is assumed that waste gases with less than 40% methane by volume are not suitable for the operation of a combined heat and power plant.

As alternatives to adsorption processes there are absorption processes which make use of the good solubility of the methane companion gases in water, in order to separate the methane. For example carbon dioxide, hydrogen sulphide and ammonia—depending on the pH value—dissolve up to 100,000 times better in water than methane. Standard processes are the cold amine wash (MEA wash) and the alkali wash. Here the biogas is freed from the acid gases in a first rectification column. In a second column, the dissolved gas is expelled. The washing agent may be fed back into the first column.

Besides the classic absorption processes, a number of exotic absorption processes are also known. Described in DE 44 19 766 A1, DE 103 46 471 A1 and in DE 10 2005 010 865 A1 are photosynthetic systems which store CO₂ and H₂S in biogas with a great use of light energy. In US 2003/0143719 A1 it is proposed to wash CO₂ specially from the gas with a solution containing carboanhydrase. This enzyme accelerates the adjustment of the carbonic acid equilibrium, thereby reducing hysteresis effects during the absorption/desorption of the CO₂ in water.

Gas permeation is a method of separating CO₂ and methane which has been known for quite some time (e.g. U.S. Pat. No. 4,518,399 and U.S. Pat. No. 5,727,903). An example for the treatment of biogas using a gas permeation plant is described in DE 100 47 264 A1. The crude biogas is directed over a membrane. CO₂ and H₂S dissolve in the membrane and diffuse through it to form a permeate. To provide the necessary driving gradient, the gas flow which does not pass through the membrane, the retentate, is put under pressure, to create a pressure gradient between the retentate and the permeate. In the ideal case, however, the flow through the membrane is not convective. The advantage of this process is the simple setup. Only a compressor and a membrane module are needed. Especially in the case of small plants, the relatively low investment costs are recovered very quickly. In addition, this is also a continuous process which manages without process chemicals or other auxiliaries. The disadvantage of this process is that several membrane stages are needed for complete separation of the methane.

In feeding processed biogas into the natural gas grid, constant availability of the grid for gas storage is often assumed. A conventional in-fed biogas plant is unable to react to saturation of the natural gas grid. The “Kombikraftwerk” [combi power plant] (www.kombikraftwerk.de) for example stores surplus methane locally in gas holders or in the gas grid. Matching of the amount of substrate to the energy or gas demand is not possible since, at least in the case of high-load biogas plants, the biology reacts sensitively to fluctuations in feed rate.

Ceramic membranes are known from a Final Project Report “Gas Separations using Ceramic Membranes” by Paul K. T. Liu, Media and Process Technology Inc., USA, published on 5 Jan. 2006. These membranes are used to separate specific components from gas flows. One example shows an application by which CO₂ is separated from a gas flow.

Also known is the use of polymer membranes for the separation of carbon dioxide from gas flows.

DE 10 2004 044 645 B3 describes a method of producing bio natural gas. In this method, biogas is converted into bio natural gas by means of pressure swing adsorption or a membrane. The waste gas of the treatment should have a methane concentration of around 10% by volume or of 14% or 15% by volume. The biogas treatment is deliberately carried out with a poor level of efficiency. The waste gas is burned in a lean gas burner and the heat released thereby is used in the fermentation. No provision is made for a combined heat and power plant, since such plants cannot be operated with a lean gas with a methane content of less than 40%, and it is not desirable to feed part of the flow of the crude biogas to a combined heat and power plant. The entire crude biogas flow may therefore be used for production of the bio natural gas. Also disclosed is a variant in which the waste gas of the biogas treatment process is supplied for burning mixed with crude biogas, partly treated crude biogas and/or bio natural gas. This is intended to compensate for fluctuations in methane content.

A concept opposed to the prior art according to DE 10 2004 044 645 B3 was realised in a biogas plant with processing to bio natural gas brought into operation in Bruck/Leitha, Austria on 25 Jun. 2007. Here, crude biogas is fed directly to a combined heat and power plant, where it is converted into electricity and heat. A portion of the crude biogas is processed into bio natural gas via a membrane. The permeate or waste gas from this bio natural gas processing is fed to the combined heat and power plant, where it is burned together with the crude biogas. In this plant a considerable amount of crude biogas is always fed to the combined heat and power plant, so as to provide a sufficiently high methane content in the combustion gas. The feeding of crude biogas to a combined heat and power plant should on the other hand be avoided by the process according to DE 10 2004 044 645 B3. In this known plant, treatment is optimised for a maximum yield of methane.

In D. Asendorpf, “Strom von der Müllkippe” [“Power from the Refuse Dump”], Zeit online 45/2005, p. 45, http://hermes.zeit.de/pdf/archiv/2005/45/I-Schwachgas.pdf, the conversion into electricity of waste gas in refuse dumps is described. In the laboratory there is a micro gas turbine which can be operated with a gas with a methane content of 15%. Whether or not this also works at a landfill site is to be researched.

In W. Maier, “Arten der energetischen Faulgasnutzung” [“Types of use of fermentation gas for energy”], DWA Exchange of experience: experience of operating plants using fermentation gas/gas engines, on 15.11.2006 and 28.2.2007 in Stuttgart/Mühlhausen, see page 18, amongst other things the advantages and disadvantages of dual-fuel engines and micro gas turbines for utilisation of fermentation gas for energy are presented.

In the brochure of the company Haase “Autotherme Oxidation für Abluft and Schwachgase” [“Autothermal Oxidation for Exhaust Air and Lean Gases”]: VocsiBox®”, page 1, FE-366/6, 2002 RD, a complex and expensive apparatus for the oxidation of methane into a gas with a content of 0 to 27% methane is disclosed. In so doing, the recovery of energy is not possible.

DE 100 47 264 B4 concerns a method for the utilisation of landfill gas containing methane. The landfill gas is processed by means of gas permeation modules, with the retentate being fed to a gas engine and the permeate to a landfill body. The gas permeation modules have high permeability for CO₂.

The invention is based on the problem of devising a method and an apparatus for the production and purification of biogas, which permits highly efficient production and purification of biogas in a very simple manner.

The problem is solved by a method with the features of claim 1 and by an apparatus with the features of claim 8. Advantageous developments of the invention are set out in the relevant dependent claims.

The method according to the invention for the production and purification of biogas for feeding into a natural gas grid comprises the following steps:
production of biogas from biomass
purification of biogas by means of a separation stage which splits the crude gas flow into two flows, with one flow passing through the separation stage and being described as the lean gas flow, and the other flow being held back by the membrane and described as the methane gas flow, and the membrane being set so that the lean gas flow has a methane content of at least 20% by volume, and
the lean gas flow is converted in a combined heat and power plant into heat and electricity, wherein the combined heat and power plant used has a micro gas turbine or a dual-fuel engine, and a variable amount of the crude gas flow is fed directly to the combined heat and power plant by a bypass line which circumvents the separation stage.

Since with the method according to the invention the amount of methane in the lean gas flow is set to be relatively high, the purification of the biogas is simplified considerably, while at the same time a high quality of bio natural gas is obtained. On account of the content of at least 20% by volume of methane in the lean gas it is possible to operate, with the lean gas flow, a combined heat and power plant which has a micro gas turbine or a dual-fuel engine, without having to feed crude gas to the combined heat and power plant.

In the method according to the invention, contrary to the conventional practice, the separation stage is not optimised to the effect that the maximum amount of methane is extracted, but instead the separation stage is so optimised that the carbon dioxide content is transferred as completely as possible into the lean gas flow, while a large methane content in the lean gas flow is not only accepted but is even desired, since by this means the energy contained in the lean gas flow may be utilised efficiently by a combined heat and power plant.

In addition, a bypass line circumventing the separation stage is provided in such a way that a variable amount of the crude gas flow is fed directly to the combined heat and power plant. This makes it possible for the consumers (natural gas grid, electricity grid) to react rapidly to changes in demand. If the buffer capacity of the natural gas grid is used up, the proportion of the crude gas flow fed directly to the combined heat and power plant is increased, leading to more electricity being generated. In electricity grids there is no limitation on the amount of power fed into the grid. There is on the other hand a considerable need in electricity grids for electrical power which is quickly available for a short time, since power stations which generate electricity cannot normally increase their power output rapidly. There are however peak loads in the electricity grid which can be met with conventional technology only with considerable trouble and expense. With the method according to the invention, a large amount of power may be generated for a short time simply by increasing the crude gas flow fed directly to the combined heat and power plant. Since the combined heat and power plant may be operated continuously with the lean gas flow, the electrical output may be increased without delay. If the operator of such a plant for the generation and purification of biogas hands over control of the production of such rapidly and temporarily available electricity output to the operator of an electricity grid, then this electricity is described as control current, for which a very high rate of remuneration is paid. For a natural gas grid, the short-term loss of a supplier of the size of a biogas plant is not critical, so that electrical power may be provided at short notice without any problem. The method according to the invention therefore preferably involves an interface to the operator of an electricity grid, so that the operator of the electricity grid is able to control the crude gas flow through the bypass line by means of an automatic requisition. In addition, the lean gas flow may be treated by means of the bypass line. This means that fluctuations in methane content due to variations in composition of the biomass or the like may be adjusted through mixing a portion of the crude gas flow into the desired methane content of at least 20% or more by volume.

The power generated in the combined heat and power plant is used preferably to operate compressors at the separation stage or to feed the generated biogas into the natural gas grid. Because of this, the process is self-sufficient in energy. The low-temperature waste heat of the compressors may be used to heat a fermenter for the production of biogas from the biomass.

The high-temperature waste heat of the combined heat and power plant may be used for the heating of buildings or the like. The high-temperature waste heat is much more valuable than the low-temperature waste heat.

In this method, the separation stage may be provided with a membrane. It may however be based on a different technology, as for example the pressure swing adsorption method or an absorption method. A membrane is however preferred since on the one hand it is easy and cost-effective to provide, while on the other hand it allows for continuous operation. The generation of a lean gas flow with a methane content of at least 20% is significantly easier with a membrane than the generation of a lean gas flow with a low methane content, while at the same time the CO₂ content of the methane gas flow can be kept very low and a bio natural gas of high quality is produced.

The continuous operation of a membrane is very advantageous for operation of the combined heat and power plant. Since, with the method according to the invention, the lean gas flow has a methane content of 20% by volume, the combined heat and power plant may be operated continuously without a supply of crude gas via the bypass line. This is very advantageous for the overall operation of the plant for the following reasons:

1. The plant is continuously supplied with power and is self-sufficient in energy.
2. Purification of the biogas to produce bio natural gas takes place continuously, which allows a correspondingly continuous supply into the natural gas grid, so that buffer storage may be dispensed with altogether or need only be very small.
3. The combined heat and power plant is continuously in operation and, in the event of a short-term increase in power demand, may be switched to a higher output level by supplying crude gas through the bypass line.

The invention is explained below by way of example with the aid of the drawings, which show in schematic form in:

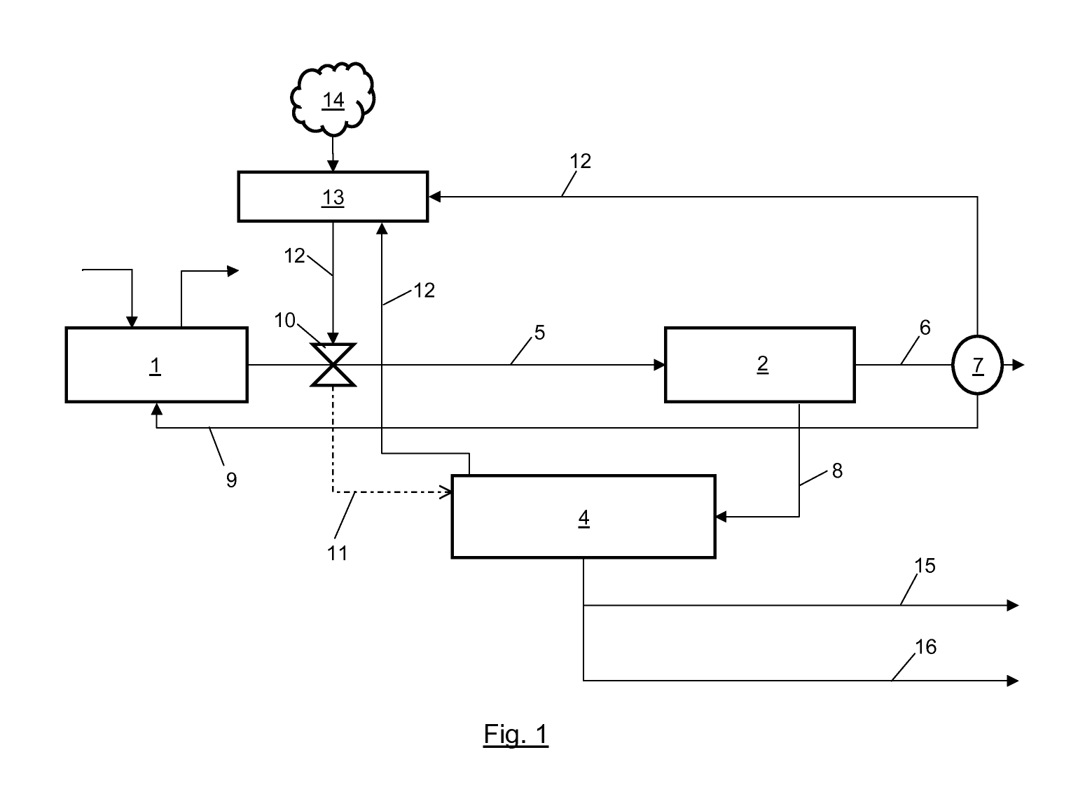

FIG. 1 an apparatus according to the invention for the production of biogas, in a block diagram, and

FIG. 2 an apparatus for the production of biogas according to the prior art, in a block diagram.

The apparatus according to the invention for the production and purification of biogas comprises a fermenter 1 for the production of biogas from biomass, a separation stage 2 for purification of the biogas, and a combined heat and power plant 4 to produce heat and electric current. The fermenter 1 is connected to the separation stage 2 via a crude gas line 5. In the separation stage 2, the crude gas is divided into a lean gas flow and a methane gas flow. The methane gas flow is taken via a methane gas line from the separation stage 2 to a compressor 7. The compressor 7 compresses the methane gas so that it may be fed into a natural gas grid. The compressor 7 is thermally coupled to the fermenter 1 via a heat exchanger circuit 9, in order to feed the heat generated in the combined heat and power plant to the fermenter 1 for the production of biogas.

The lean gas is fed by means of a lean gas line 8 from the separation stage 2 to the combined heat and power plant 4. The combined heat and power plant 4 has an engine, e.g. a micro gas turbine, and a generator connected to the engine for the generation of electricity.

An option is to provide in the crude gas line 5 a two-way valve 10, to which a bypass line 11 leading to the combined heat and power plant 4 is connected.

The combined heat and power plant 4, the compressor 7 and the valve 10 are connected to a control unit 13 via control lines 12. The control unit 13 may be connected to a data network 14, for example to the internet.

The combined heat and power plant 4 has an electrical output 15 for feeding electrical energy into an electricity grid. It also has a heat output 16, through which heat may be withdrawn. This heat may be used e.g. to supply an industrial drying process.

The separation stage preferably has a membrane (not shown) as separating means. Such membranes may be obtained from the company Membrane Technology and Research, Inc., Menlo-Park, Calif., USA. In this connection, use is made of the varying permeability of the membrane material for the different gas molecules. Such membranes may therefore be used not only for the joint separation of carbon dioxide and sulphur dioxide but also for the selective separation of hydrogen sulphide and carbon dioxide in multi-stage plants. At the membrane a specific portion of the crude gas flow is held back and forms a methane gas flow, also described as the retentate.

The portion of the crude gas flow passing through the membrane forms a lean gas flow, also described as the permeate.

The membranes are preferably ceramic membranes. It is however also possible for polymer membranes to be used.

Preferably the separation is carried out in a single stage, i.e. the crude gas flow is passed over just one membrane for the separation of a specific component. In this connection, however, it is possible to connect several membranes in series, with each being selective for a particular component. Preferably the crude gas flow is under pressure, so that there is a pressure gradient at the membrane which assists the separation into the methane flow and the lean gas flow.

The pressure gradient at the membrane and the membrane material are so aligned that the lean gas flow has a methane content of around 30 to 35% by volume. A methane content from around 25% by volume up to less than 40% by volume and even up to 50% by volume may also be expedient. A compressor (not shown) may also be provided for setting the pressure gradient at the membrane stage.

Such a lean gas flow can be converted directly into heat and power in a combined heat and power plant, with the methane it contains being burned. A combined heat and power plant suitable for making use of a lean gas flow preferably has a micro gas turbine. A micro gas turbine of this kind may be obtained for example from the company Capstone Turbine Corporation, USA under the trade designations C65 and C60-ICHP. Such micro gas turbines may be operated efficiently with lean gas. The constant combustion of the gas in a turbine is advantageous for the use of lean gas.

The membranes contain for example hollow fibres. The use of such membranes for the treatment of biogas is described in Schell, William J. P., “Use of Membranes for Biogas Treatment”, Energy Progress, June 1983, 3^{rd} edition, no. 2, pages 96-100. In the method according to the invention, the process parameters are set so that virtually all of the carbon dioxide passes through the membrane. By this means, a methane gas flow with a methane content of more than 99% methane by volume is obtained. This is therefore a very pure methane gas flow which satisfies the usual specifications for bio natural gas. The term bio natural gas is used to describe biogas which has natural gas quality. The natural gas quality is regulated for example in DVGW G 260, 261 and 262, and requires a methane content of at least 96% by volume.

Since the parameters at the membrane are set so that carbon dioxide passes through almost completely, a very pure methane gas flow is therefore obtained. The lean gas flow contains a relatively high methane content which is not desired in conventional processes. With the present method, however, this represents an advantage, since the lean gas flow may be used directly in operation of the combined heat and power plant.

A further significant advantage of the optimisation of the separation stage in respect of the carbon dioxide to be separated lies in the fact that the separation may be effected in a single step. Single-step separation without recirculation or feedback may be carried out very easily and cost-effectively.

The increase in the methane content of the lean gas flow, as compared with conventional processes, thus gives simultaneously the three following benefits: a pure methane gas flow of natural gas quality is obtained; the separation stage is a simple operation and may be operated continuously by a membrane; and the lean gas flow is suitable for operation of a combined heat and power plant.

At the valve 10, part of the crude gas flow may be fed directly to the combined heat and power plant 4 via the bypass line 11. Since micro gas turbines may be operated with a wide spectrum of gas composition, the combined heat and power plant 4 may be operated as required directly with crude biogas or with a mixture of crude biogas and lean gas. Preferably the valve 10 is so designed that the overwhelming majority of the crude gas flow and in particular the whole of the crude gas flow may be fed through the bypass line 11 to the combined heat and power plant 4.

Such a requirement exists for example when the natural gas grid has no further capacity for the feeding-in of bio natural gas. Gas grids generally have limited buffer and equalisation capacity. Moreover there are often short-term over-supplies of bio natural gas. Once the maximum pressure has been reached in the natural gas grid, it is therefore often not possible to feed in further bio natural gas. In the case of conventional methods, the surplus bio natural gas must then be flared off. Apparatus for the production of bio natural gas is therefore generally set up at locations where the natural gas grid has relatively high equalisation capacity, in order to avoid flaring. Such locations are however limited, and restrict considerably the range of sites where conventional facilities for the production of bio natural gas may be installed. Alternatively it would be possible to provide a fairly large gas holder. Owing to cost and space factors, however, the size of any gas holder is generally limited, and is typically designed to accept 0.5-2 hours' gas production. If it is desired to equalise higher capacity levels, then the gas holder would have to be correspondingly larger. Since this is not desirable, conventional facilities for the production of bio natural gas are very limited in their equalisation capacity relating to the transfer of bio natural gas, and the electricity generated can as a rule not be varied freely. Through the provision of the bypass line 11 it is possible to convert surplus bio natural gas in the combined heat and power plant into power and heat. The electricity may be fed into the electricity grid and, at least in Germany, is remunerated under a fixed tariff.

It is therefore possible, in a simple manner, to control specifically the amount of bio natural gas produced, without having to flare off bio natural gas in the event of varying consumption capacity. Control in the vicinity of the fermenter is not possible in practical terms, since it is much too slow-reacting as compared with the requirements of the natural gas grid. Nevertheless, in principle there is no need for a gas holder to ensure continuous operation.

A further advantage of the bypass line 11 lies in the fact that, if required by the network operator of the electricity grid, quite large amounts of electrical power may be made available very quickly. The network operator of an electricity grid must often react at very short notice to peaks in demand for power. Electricity producers who are able to provide retrievable power quickly transfer the control of their electricity production at least in part to the network operator of the electricity grid. This is achieved by means of remote monitoring, which gains access via the data network 14 to the control unit 13, which contains a suitable interface for the network operator of the electricity grid. As required, the operator of the electricity grid may retrieve the electrical power directly. Such power is described as control current and obtains a very high price. Through the provision of the bypass line 11 it is possible to provide such a control current, since when needed a continuous crude gas flow may be fed rapidly to the combined heat and power plant 4, in order to increase the amount of electricity produced. Since the turbine of the combined heat and power plant is in continuous operation, there is no starting-up time, but instead the electricity output may be increased within a few seconds. On account of the high levels of remuneration for control current, this is very lucrative for the operator of such an apparatus for the production and treatment of bio natural gas. Of course it is not possible during provision of the control current to feed a large amount of bio natural gas into the gas grid at the same time. Since however the natural gas grid is very passive, it is not a problem for the operation of such an apparatus if the production of bio natural gas is reduced or stopped altogether for a short period of time.

Through the provision of the bypass line in combination with a gas holder with a capacity of around 2 to 6 hours' gas production, the combined heat and power plant may be operated continuously at a high output level for around 5 to 15 hours. It is even possible to treat and supply bio natural gas simultaneously. Here the combined heat and power plant is supplied with biogas from both the gas holder and also from current biogas production.

The micro gas turbine of the combined heat and power plant 4 is so designed that it can generate 1.5 to 2 times the electrical power, corresponding to the energy flow of the methane contained in the lean gas. Such a generous design of the micro gas turbine is expedient for two reasons. Firstly the CO₂ contained in the lean gas flow must be transported by the micro gas turbine, which is possible only if the micro gas turbine has adequate capacity. On the other hand it should also be possible, if required, for the entire crude gas flow of the micro gas turbine to be fed through the bypass line, which makes sense only if the micro gas turbine has suitable capacity for converting the entire methane content into mechanical or electrical energy. In practice the necessary capacity may be obtained through the provision of several micro gas turbines. In the present embodiment, two micro gas turbines are used; working together in the combined heat and power plant they are able to generate a maximum electrical output of 400 kW.

The energy and mass balance of the embodiment, described above, of the apparatus for the production and treatment of biogas is explained below.

The fermenter produces 470 Nm³/h of crude biogas with a methane content of around 65% by volume, which is fed to the separation stage 2. The thermal energy of the crude biogas is 3379.1 kW.

In the separation stage, a methane gas flow of 235 Nm³/h with a methane content of 99% by volume and thermal energy of 2599 kW is separated and fed into the natural gas grid. At the same time a lean gas flow 235 Nm³/h with a methane content of 35% by volume and a thermal energy content of 760 kW is produced.

In the combined heat and power plant 4 this lean gas flow is converted by a micro gas turbine into heat and electrical power. The thermal efficiency is 56%, giving 548.6 kW of thermally useful heat. The use of a micro gas turbine also has the advantage that the waste gas temperature is very high (for example 309° C.), so that the thermal energy may be used further in a highly efficient manner. The electrical efficiency of the combined heat and power plant is around 29%, leading to generation of 284 kW of electrical power.

Since the methane is utilised completely in both the lean gas flow and in the methane gas flow, a methane yield of 100% by volume is obtained.

In comparison with the above, the energy and mass balance for the production and treatment of biogas using the plant shown in FIG. 2 will now be explained. Here too the starting point is a biogas production of 470 Nm³/h of crude biogas with a methane content of around 65% by volume. The biogas treatment is effected by the pressure swing adsorption process. For this purpose the crude biogas is compressed to around 6×105 Pa (6 bar), water is drawn off, and the compressed crude biogas flow is pressed into the separation stage 2 at around 20° C. The separation stage contains an adsorber vessel with a carbon-based molecular sieve. The methane-enriched gas is fed into the gas grid. The carbon dioxide desorbed during depressurisation, and other gaseous impurities are exhausted under vacuum and released into the atmosphere. With this method there is no recirculation of the waste gas arising in the separation stage, and a methane yield of 90% by volume is obtained. The power requirement for the biogas treatment comes to 88 kW, which must be supplied from an external source. With this separation stage, a lean gas flow of 184.3 Nm³/h and a methane content of 17% by volume and a thermal output of 345.69 kW are drawn off. The heat is used to heat water in a hot water boiler. The thermal efficiency of the water heating comes to 88% by volume, i.e. 304.20 kW are introduced into the fermentation for boiler heating. The heat used by the boiler thus amounts to 12% by volume or 41.48 kW. The boiler heat (here 304.2 kW) is carried over into the biogas production and used there to maintain the fermentation temperature at between 30° C. and 40° C. 285.7 Nm³/h of bio natural gas with a methane concentration of 96% by volume and an energy content of 3033.4 kW are obtained. The overall energy efficiency is therefore 96.3%.

The table below gives the key values from the energy balance of the method according to the prior art and the method according to the invention, alongside one another:

| | Method according to the | |
|---|---|---|
| | invention | Prior art |
| Energy input: crude biogas | 3379 | 3379 |
| (kW) | | |
| Additional energy input: | 52 | 88 |
| electricity (kW) | | |
| Total energy input (kW) | 3379 | 3467 |
| Bio natural gas (kW) | 2399 | 3033.4 |
| Useful heat (kW) | 549 | 304.2 |
| Electricity generated (kW) | 284 | 0 |
| Total energy output (kW) | 3232 | 3337.6 |
| Losses (kW) | 147 | 41.5 |
| Energy efficiency in (%) | 95.6% | 96.3% |

A major benefit of the method according to the invention is that heat and power are provided for internal use (=production and treatment of biogas) and for existing customers. The method according to the invention is completely self-sufficient in energy, i.e. neither heat nor power need be supplied from external sources. In specific cases however it may be sensible to feed the electricity generated into an electricity grid and to draw the power required from an electricity grid, since the payment for feeding in power is often greater than the costs of power supplied. This makes the production of the bio natural gas and the electricity attractive. In addition, the separation stage is of a very simple design and may be operated continuously.

The invention has been explained above with the aid of an embodiment in which a combined heat and power plant with a micro gas turbine is used. A micro gas turbine of this kind is the preferred engine, since a micro gas turbine is able to operate with a wide spectrum of gas composition, so that a varying methane content in the gas flow supplied to the micro gas turbine leads to no impairment of operation. However a micro gas turbine does require a minimum methane content of around 30% by volume. Another advantage of a micro gas turbine is the high waste gas temperature, which allows very advantageous utilisation of the waste heat.

Instead of a micro gas turbine, a dual-fuel engine suitable for lean gas may also be used. Such a dual-fuel engine is a reciprocating engine, into the swept volume of which there is injected an igniting jet, for example an oil jet of vegetable oil, in addition to the lean gas. Dual-fuel engines of this kind are made and sold by the company Schnell Zündstrahlmotoren AG and Co. KG, Amtzell/Germany (www.schnellmotor.de). In principle, with a dual-fuel engine of this kind, lean gas with any desired methane content may be converted into thermal and electrical energy. Here however the additional supply of another source of energy, as for example vegetable oil, is necessary. But also, with a dual-fuel engine of this kind, it is possible to run the combined heat and power plant continuously, and to react quickly to changes in demand (overcapacity of bio natural gas, control current).

In the above embodiment, a membrane is used in the separation stage. A membrane is the preferred embodiment of a separation stage, since it is of simple design and may be used continuously and cost-effectively. The bypass line 11 is also suitable for types of apparatus for the production and purification of biogas which use an adsorption or absorption means as separation stage. Such separation stages may also be set so that the carbon dioxide contained in the crude gas flow is transferred almost entirely into the lean gas flow, and the lean gas flow has a considerable methane content. For such separation stages, however, buffer storage vessels are necessary if aim is to operate the plant on a continuous basis.

### LIST OF REFERENCE NUMBERS

1 fermenter
2 separation stage
3 lean gas burner
4 combined heat and power plant
5 crude gas line
6 methane gas line
7 compressor
8 lean gas line
9 heat exchanger circuit
10 two-way valve
11 bypass line
12 control line
13 control unit
14 data network
15 electrical output
16 heat output

1. Method for the production and purification of biogas for feeding into a natural gas grid comprising:
production of biogas from biomass
purification of biogas by a separation stage which splits the crude gas flow into two flows, with one flow passing through the separation stage and being described as a lean gas flow, and the other flow being held back by the separation stage and described as a methane gas flow, and the separation stage being set so that the lean gas flow has a methane content of at least 20% by volume, and
the lean gas flow is converted in a combined heat and power plant into heat and electricity, wherein the combined heat and power plant used has a micro gas turbine or a dual-fuel engine,
a variable amount of the crude gas flow is fed directly to the combined heat and power plant by a bypass line which circumvents the separation stage.

2. Method according to claim 1, wherein a membrane for splitting the crude gas flow is provided in the separation stage.

3. Method according to claim 1, wherein the separation stage is set so that the lean gas flow has a content of at least 25 or 30% methane by volume.

4. Method according to claim 1, wherein the biogas is purified by only a single stage.

5. Method according to claim 1, wherein the crude gas flow and/or the methane gas flow are compressed by a compressor, and the heat occurring in this process is used in the production of biogas.

6. Method according to claim 1, wherein electricity made available in the combined heat and power plant is used to operate a compressor.

7. Method according to claim 1, wherein the combined heat and power plant is operated continuously, even when no crude gas flow is being fed through the bypass line.

8. Apparatus for the production and purification of biogas, comprising:
a fermenter for the production of biogas from biomass.
a separation stage for the purification of the biogas, which splits the crude gas flow into two flows, with one flow passing through a membrane and being described as a lean gas flow, and the other flow being held back by the membrane and described as a methane gas flow, and the membrane being set so that the lean gas flow has a methane content of at least 20% by volume,
a combined heat and power plant to convert the lean gas flow into heat and electricity, wherein the combined heat and power plant includes a micro gas turbine or a dual-fuel engine, and
a bypass line which circumvents the separation stage to provide a variable amount of the crude gas flow directly to the combined heat and power plant.

9. Apparatus according to claim 8, wherein the separation stage has the membrane.

10. Apparatus according to claim 9 wherein the membrane is a ceramic membrane or a polymer membrane.

11. Apparatus according to 8 wherein only a single separation stage is provided.

12. Apparatus according to claim 8 wherein a compressor is provided to compress the methane gas flow, and is connected by a shaft driven by the combined heat and power plant.

13. Apparatus according to claim 8, further comprising a control unit, which has an interface for an operator of an electricity grid, so that in the event of a demand request, part of the crude gas flow is fed automatically to the combined heat and power plant via the bypass line.

14. Apparatus according claim 8, wherein the apparatus implements a method for the production and purification of biogas for feeding into a natural gas grid comprising:
production of biogas from biomass;
purification of biogas by means of a separation stage which splits the crude gas flow into two flows, with one flow passing through the separation stage and being described as the lean gas flow, and the other flow being held back by the separation stage and described as the methane gas flow, and the separation stage being set so that the lean gas flow has a methane content of at least 20% by volume, and
the lean gas flow is converted in a combined heat and power plant into heat and electricity, wherein the combined heat and power plant used has a micro gas turbine or a dual-fuel engine,
a variable amount of the crude gas flow is fed directly to the combined heat and power plant by a bypass line which circumvents the separation stage.

15. Apparatus according to claim 8, wherein the bypass line is coupled by means of a valve to a crude gas line leading from a fermenter to the separation stage, wherein the valve provides an overwhelming proportion of the crude gas flow through the bypass line.

16. Method according to claim 2, wherein the separation stage is set so that the lean gas flow has a content of at least 25 or 30% methane by volume.

17. Method according to claim 16, wherein the biogas is purified by only a single stage.

18. Method according to claim 17, wherein the crude gas flow and/or the methane gas flow are compressed by a compressor, and the heat occurring in this process is used in the production of biogas.

19. Method according to claim 18, wherein electricity made avail in the combined heat and power plant is used to operate a compressor.

20. Method according to claim 19, wherein the combined heat and power plant is operated continuously, even when no crude gas flow is being fed through the bypass line.

21. Apparatus according to claim 10, wherein only a single separation stage is provided.

22. Apparatus according to claim 10, wherein a compressor is provided to compress the methane gas flow, and is connected by a shaft driven by the combined heat and power plant.

23. Apparatus according to claim 21, wherein there is provided a control unit, which has an interface for an operator of an electricity grid, so that in the event of a demand request, part of the crude gas flow is fed automatically to the combined heat and power plant via the bypass line.
